(19) United States
(12) Patent Application Publication
(10) Pub. No.: US 2005/0165672 A1
(43) Pub. Date: Jul. 28, 2005

(54) System and method for bundling telecommunications and utilities into a mortgage

(76) Inventor: John J. Pembroke, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/219,797

(22) Filed: Aug. 14, 2002

(51) Int. Cl. G06F 17/60

(52) U.S. Cl. 705/38

(57) ABSTRACT

A system and method is provided for delivering products and services to a homebuyer during a mortgage transaction. In one example, a bundling company sells products and services to a client at wholesale prices. A cost of selected products and services is calculated. The bundling company integrates the cost of the selected products and services into a purchase price of the home. An appraisal of the home including the selected products and services is acquired. The bundling company acquires an approval of a mortgage for the purchase price of the home. The mortgage is closed. The bundling company orders the products and services from suppliers.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention generally relates to products and services in relation to home mortgages and, more particularly, to the bundling of various products and services as real property into a home mortgage.

2. Discussion of Background

Mortgages are used to finance over 98% of all home purchased in the United States. Mortgage bankers originate the loans then sell the loans to Freddie Mac and Fannie Mae. Therefore, Freddie Mac and Fannie Mae set the policy on what loans they purchase. Freddie Mac and Fannie Mae will only purchase loans that are Real Property and do not contain Personal Property.

“Property” is classified as either Real Property or Personal Property. Generally speaking, Personal Property can be removed from the home. Real Property is the house structure and anything attached to it, such as a built-in home theater. A television is not “built-in” and therefore can be removed by the owner. As such, the TV is classified as Personal Property.

Personal property cannot be included under the umbrella of a home mortgage. Nevertheless, a large part of homebuyer's or homeowner's expenses includes personal property.

### SUMMARY OF THE INVENTION

It has been recognized that what is needed is a way to combine various products and services, which have been traditionally considered personal property, into a home mortgage. Broadly speaking, the present invention fills this need by providing a system and method for treating products and services as real property, and then allowing consumers to purchase these products and services via mortgage financing. It should be appreciated that the present invention can be implemented in numerous ways, including as a process, an apparatus, a system, a device or a method. Several inventive embodiments of the present invention are described below.

In one embodiment, a method is disclosed for a bundling company to provide products and services to a homebuyer in a house sale. The method comprises selling products and services to a client at wholesale prices; calculating a cost of selected products and services; integrating the cost of the selected products and services into a purchase price of the home; acquiring an appraisal of the home including the selected products and services; acquiring an approval of a mortgage for the purchase price of the home; allowing the mortgage to close; and ordering the products and services from suppliers of the products and services.

In another embodiment, a method is disclosed for a bundling company to provide products and services to a homeowner during a mortgage transaction. The method comprises offering various products and services to the homeowner via a client; receiving the homeowner's selection of products and services; acquiring an appraisal of the home including the selected products and services; receiving confirmation that the mortgage transaction has closed; receiving payment for the products and services; calculating costs of the products and services; and placing costs of products and services into a trust account on behalf of the homeowner.

In still another embodiment, a method is disclosed for a homebuilder or a land developer of a bundling company to provide products and services to a homebuyer during a house sale. The method comprises purchasing products and services from the bundling company at wholesale prices; reselling the products and services to the homebuyer at resale prices; closing the house sale; and paying the bundling company the wholesale prices for the products and services.

In yet another embodiment, a method is disclosed for a real estate broker or a mortgage company of a bundling company to provide products and services to homeowners during a mortgage transaction. The method comprises offering various products and services to the homeowner at resale prices; receiving a selection of products and services from the homeowner; sending the selection of products and services to the bundling company; acquiring an appraisal of the home including the selection of products and services; and closing the mortgage transaction.

Advantageously, the bundling company bundles products and services, typically considered personal property, as real property into a mortgage. Bundling allows a bundling company to reduce the cost of customer acquisition for each product and service by spreading the customer acquisition cost over numerous products and services, and over a prepaid time period. In particular, by integrating the products and services into the home mortgage, a consumer receives significant cash-flow benefits.

The invention encompasses other embodiments of a method, an apparatus, and a computer-readable medium, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram illustrating the environment in which a bundling company operates, in accordance with an embodiment of the present invention.

FIG. 2 is a flowchart of a method for a bundling company to provide products and services to homebuyers in a house sale, in accordance with one embodiment of the present invention.

FIG. 3 is a flowchart of a method for bundling company to provide products and services to homeowners during a mortgage transaction, in accordance with one embodiment of the present invention.

FIG. 4 is a flowchart of a method for a builder or developer to provide products and services to homebuyers during a house sale, in accordance with one embodiment of the present invention.

FIG. 5 is a flowchart of a method for a real estate broker or mortgage company to provide products and services to homeowners during a mortgage transaction, in accordance with one embodiment of the present invention.

### DESCRIPTION OF THE PREFERRED EMBODIMENTS

An invention for a system and method of providing products and services to a homebuyer during a mortgage transaction is disclosed. Numerous specific details are set forth in order to provide a thorough understanding of the present invention. It will be understood, however, to one skilled in the art, that the present invention may be practiced without some or all of these specific details.

General Overview

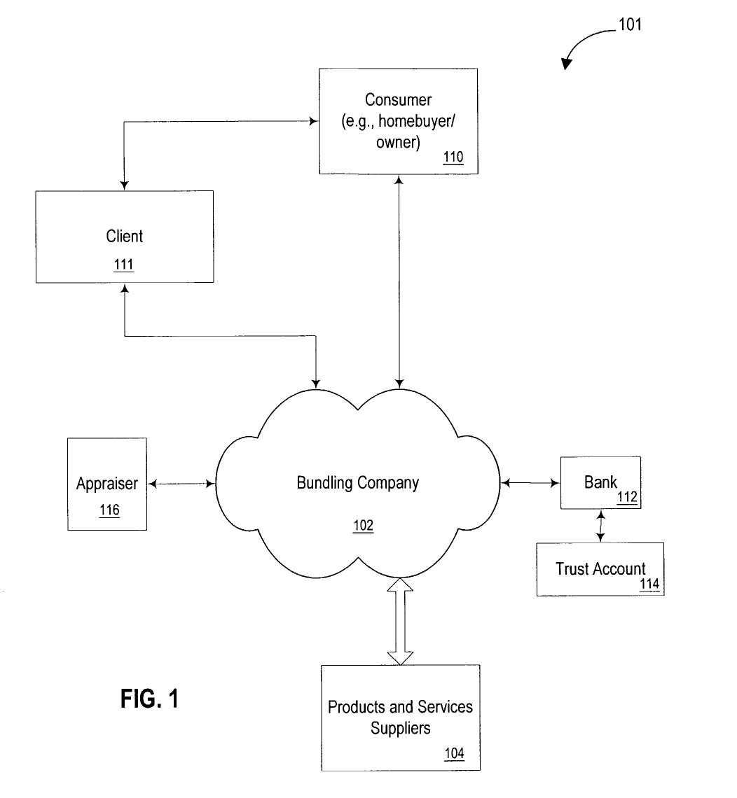

FIG. 1 is a block diagram illustrating the environment in which a bundling company 102 operates, in accordance with an embodiment of the present invention. The bundling company 102 has relationships with numerous suppliers of products and services 104, including telecommunications (e.g., telephone—dial-tone and long distance; video—satellite and cable; Internet access; home security) and energy (e.g., gas electric, water). In other words, the bundling company 102 is “supplier agnostic,” meaning that the bundling company 102 can contract with numerous suppliers of products and services, and not exclusively one supplier.

The bundling company 102 negotiates deeply discounted prices for the products and services. The bundling company 102 then offers the products and services at wholesale prices to its clients 111, such as homebuilders, land developers, real estate brokers, mortgage companies and other sales channels established by the bundling company 102. The clients 111 will make the products and services available to their customers, which may be consumers 110 purchasing a new or used home. The clients will usually mark-up the products and services by approximately 40%. The bundling company 102 can also sell directly to the consumers 110.

The consumer 110 (i.e., the customer of the client 111) can customize the products and services to their specific needs and desires. In one embodiment, the monthly price of each product and service is multiplied by 60 months to determine the amount of funds needing to go into the customer's “bucket.” The bucket amount is included in (1) the purchase price of the new home, which is then financed by the customer through a first mortgage loan, or (2) a refinanced mortgage loan or home equity loan to an existing used home.

When the customer has selected all of the products and services, as well as all of their upgrades in the case of a new home, a mortgage calculation is run to determine if the customer “still qualifies” for the mortgage loan. The products and services amount is also sent to an appraiser 116. If approved, the mortgage loan is ready for closing awaiting the appraisal.

The appraisal process requires the appraiser 116 to include the full value of the products and services in the value of the home. In one embodiment, a national on-line appraisal network of roughly 10,000 appraisers 116 is available to value the dollar amount of the products and services as described by the bundling company 102 as the basis for the valuation increase in the appraisal.

At the loan closing, the bundling company 102 receives the payment for the products and services. The bundling company 102 then takes the products and services cost component (the funds required to pay for the products and services over the 60 month term) and places it into a trust account 114 administered by a bank 112.

On a monthly basis, the products and services suppliers 104 send a single consolidated invoice to the bundling company 102. The bundling company 102 withdraws the amount from the trust account 114 and pays the products and services suppliers 104. The records of the consumer 110 are also adjusted by the bundling company 102 to reflect the payment.

In another embodiment, the bundling company 102 makes the products and services available to land developers at wholesale prices. The land developer selects the products and services and includes them in the “dirt”, the finished lots, which lots are sold to homebuilders. The products and services are then passed to the homebuilder and then to the homebuilder's customers. The process described above of financing the products and services in the mortgage loan is followed.

Products and Services as Real Property

Products and services, such as telecommunications (“telecom”) and energy, are classified as real property. To accomplish this classification, the present invention involves an approach to tie products and services to the real property.

First, the products and services are purchased in 5 year blocks. There is nothing magical about the 5 year term, except that most people move every 5 to 7 years. The procedure is to have a homeowner contract to purchase and prepay for 5 years of telecom and energy. For example, if the purchaser plans on using 400 minutes of long distance each month over 60 months, he would use 24,000 minutes. The bundling company 102 sells the long distance at $0.06 per minute. $0.06 times 24,000 minutes equals $1,440. This is the amount of the “long distance prepaid bucket”. The bundling company 102 would do the same for video (cable) service, Internet access, home security, and energy. The average package for long distance (voice), video, data (Internet), and home security may be about $5,000.

Next, the 5 year package of telecom and energy is tied to the address of the property where it will be used. If the homeowner moves, he can not take the remaining balance with him to another home. Effectively, the telecom and energy travel with the title transfer to the new homeowner.

Finally, Freddie Mac and Fannie Mae require that the amount of the mortgage and home price be validated by an appraisal. The telecom services and energy services practice represents a “Pre-paid Asset”, which can be readily identified as to the amount and being “tied to a specific property”. The logic is that if an appraiser 116 was appraising two different homes, each identical relative to size and amenities and one house had $10,000 of telecom and energy services included as a Pre-paid Asset, the appraised value of that house would be $10,000 greater.

In light of these “practices,” the telecom and energy services of the bundling company 102 could be considered real property and could be included in the mortgage amount on home loans. It is important to note that before such practices were made possible by the bundling company 102, telecommunication and energy have never before been financeable in a home mortgage.

Aggregation and Bundling Enhances the Value Proposition

The bundling company 102 allows the aggregation of the buying power of thousands of developers and builders and tens of thousands of homebuyers/owners 110. By having contracts with multiple developments and thousands of consumers, the bundling company 102 can negotiate better pricing for the telecom and energy services with greater commissions than any developer, builder or consumer can attain on their own—like a buying club.

The bundling company 102 then bundles the various telecom and energy products and services. Bundling allows the bundling company 102 to reduce the cost of customer acquisition for each product and service by spreading the customer acquisition cost over numerous products and services. In particular, by combining the products and services, such as telecom and energy, with the home mortgage a homebuyer/owner 110 can receive significant cash-flow benefits.

Next, the bundling company 102 offers voice, video, data security and energy service suppliers lower customer acquisition costs, reduction in “churn” and guaranteed payments for an initial block of time, such as five years. Having the services “pre-paid” for the initial block of time allows the bundling company 102 to reduce the “churn factor” experienced by all telecom and energy suppliers.

Consumers 110 can purchase telecom (e.g., satellite/cable entertainment, telephone/long distance services, Internet access, and home security) and energy for 10% to 20% off individual retail pricing while saving up to 80% in monthly cash flow.

As an example, the average consumer 110 spends $200 each month purchasing telephone, video-cable service, Internet access and home security. By including these services in the home mortgage loan, the average loan payment increases by about $36.00 (financed over a thirty year term). With the tax deductibility of the mortgage interest, the after tax net effective cost for the telecom services is about $28.00—a cash flow savings of $172.00 per month.

Developer and Builder Interface with Homebuyer/Owner

The primary business strategy of the bundling company 102 is to have the land developer bundle the telecom and energy services into the “dirt”, the developed lots. When the homebuilder purchases the lots, the telecom and energy are defaulted into the new home at the time of construction, allowing all consumers to automatically receive the telecom and energy. The homeowner can upgrade their telecom or energy package when selecting the home's construction upgrades like carpet and countertops.

The homebuyer/owner 110 can purchase the telecom and energy of the bundling company 102 at any time, for example, when they purchase a new or used home, when they refinance their present home, or when taking out a home equity loan or second mortgage.

Examples of Products and Services

The following discussion sets forth examples of how the bundling company 102 provides products and services to consumers. The embodiment is not so limited to the specific dollar amounts nor to other specific values given. The given values are for exemplary purposes only.

Base Telecom Services—the base telecom package of the bundling company 102 consists of 150 channels of video plus 50 minutes of long distance. The “street retail” price for this package is approximately $62.00. The bundling company's clients can purchase this package for a “wholesale” price of $39.95.

Video (TV) Services—generally, video (TV) entertainment is delivered via cable or satellite. The video service of the bundling company 102 includes standard, local and premium channels. The bundling company 102 guarantees that its consumer pricing will be at least 10% less than normal “street retail” pricing for this service. The bundling company's “wholesale” pricing allows developers and builders to receive margins of 40% or more on the resale of the services.

Long-Distance Telephone Service—the bundling company 102 has contracts with four different long distance providers. The bundling company 102 continually negotiates its rates among these providers. The best value proposition is then offered to our clients. The average consumer uses about 400 minutes per month and pays $0.10 per minute. The bundling company's clients can purchase the bundling company's long distance at $0.064 cents “wholesale” price flat rate per minute on interstate calls with no monthly fee.

Internet Service—the average consumer pays $23.95 for Internet access through American Online (AOL). The bundling company 102 offers dial-up Internet access at $15.95 per month for the first account and only $9.95 for each additional account at the same address. The bundling company's “wholesale” price is $10.95 for the first account, giving developers and builders a 119% “wholesale to street” margin on this service. High Speed and wireless Internet access is also available as an upgrade in certain areas.

Home Security Service—the average consumer 110 pays $29.95 for full security monitoring. The bundling company 102 customers can order home security starting as low as $21.95 per month. The bundling company's clients “wholesale” price is $15.95.

Structured Wiring—structured wiring is a telecom product and is the equipment and wiring necessary to distribute voice, video and data services throughout the home. Costs range from $950 to approximately $1,500 including equipment and installation. The bundling company 102 guarantees that its structured wiring package will be at least 10% less than comparable bids.

Energy—Energy (e.g., utilities, such as electricity, gas, water, waste disposal, and recycling), following the previous procedures, can also be bundled into the home price and financed with a federally guaranteed home mortgage loan.

Business Strategy

The business strategy of the bundling company 102 overlaps at least six industries, including the telecom industry, the residential resale marketplace, single-family homebuilding industry, the mortgage finance business, and the energy industry. There is an enormous opportunity to exploit these markets with a converged telecom and energy solutions for new single-family homeowners. The bundling company 102 targets the developer and builder market with the notion that the developer and builder demand for telecom will drive and shape the bundling market.

The ultimate customer is the consumer 110, which includes homeowners and homebuyers. The best time to capture the homeowner's business is when the consumer 110 is purchasing a new home or refinancing an existing home. This means that the sales channels of the bundling company 102 involve homebuilders, land developers, real estate brokers and mortgage companies. The best sales channel is the residential land developer. The next best sales channel is the homebuilder.

During the purchasing process, the customer realizes that the customer is already purchasing these services. Therefore, the consumer 110 grapples with the issue of whether the consumer wants to pay monthly the retail price or purchase the services through the bundling company 102 and significantly reduce his monthly telecom costs by about 80%. The consumer 110 will likely choose to purchase the services using the bundling company's unique program.

The bundling company 102 as the consumer's advocate—the bundling company's unique role as a “consumer advocate” allows the bundling company to manage the telecom solution for the consumer as well as provide contractual protections that are not available in traditional, direct relationships with telecom suppliers. An entity that has a traditional, direct relationship with telecom suppliers is typically faced with a conflict of interest that does not allow the entity to be a consumer advocate. The bundling company 102, however, is not burdened with this conflict of interest.

Consider the following example of the bundling company's role as a consumer advocate. If the price of long distance service drops, the bundling company will adjust its consumer's pricing to reflect the new lower price by adding more minutes to the consumer's account. In some cases, the bundling company 102 will switch the long distance provider to effect consumer savings. If the price of the service increases, the bundling company 102 will negotiate the price increase, thereby, minimizing the consumer's rate increase. All told, the bundling company's Telecom Advocacy program provides information, explanations of complexities, and generally facilitates the consumer's transaction and service.

The bundling company 102 guaranties telecom payments—when the bundling company 102 is paid for the services, the bundling company 102 places the cost component of the telecom services into a national trust account. In the unlikely event that the bundling company 102 files for bankruptcy (or otherwise becomes unable to perform its duties to the home buyer/owner 110), the funds held by the bank 112 in the trust account 114 will be released to the bundling company's customers. No other telecom company provides such a security for payment.

Process Overview

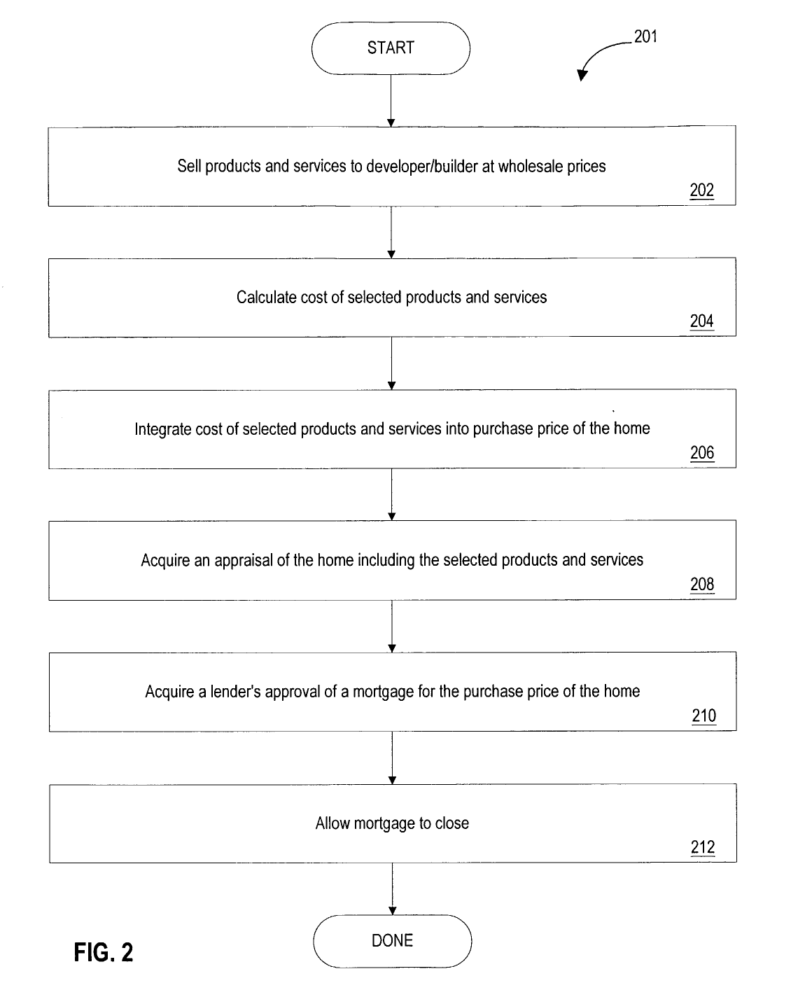

FIG. 2 is a flowchart of a method 201 for a bundling company 102 to provide products and services to homebuyers 110 in a house sale, in accordance with one embodiment of the present invention. The method 201 starts in step 202 where the bundling company 102 sells products and services to a builder or developer (generically referred to as a “client”) at wholesale prices. Next, in step 204, the bundling company 102 calculates the cost of products and services that the consumer (i.e., homebuyer) has selected.

Moving to step 206, the bundling company 102 integrates the cost of the selected products and services into the purchase price of the home. Then, in step 208, the bundling company 102 acquires an appraisal of the home including the selected products and services. In step 210, the bundling company 102 then acquires a lender's approval of a mortgage for the purchase price of the home. The bundling company 102 then, in step 212, allows the mortgage loan to close.

Some additional steps carried out by the bundling company 102 include tying the block of time to real property where the products and services will be used, receiving payment for the selected products and services, placing the costs of the selected products and services into a trust account 114, scheduling funds placed in the trust account 114 to be released to the homebuyer 110 upon an inability of the bundling company 102 to perform its duties to the homebuyer, ordering the products and services from suppliers of the products and services, receiving a single consolidated invoice from the products and services suppliers, withdrawing from the trust account 114 the amount of the single consolidated invoice, and paying the products and services suppliers. The method 201 is then done.

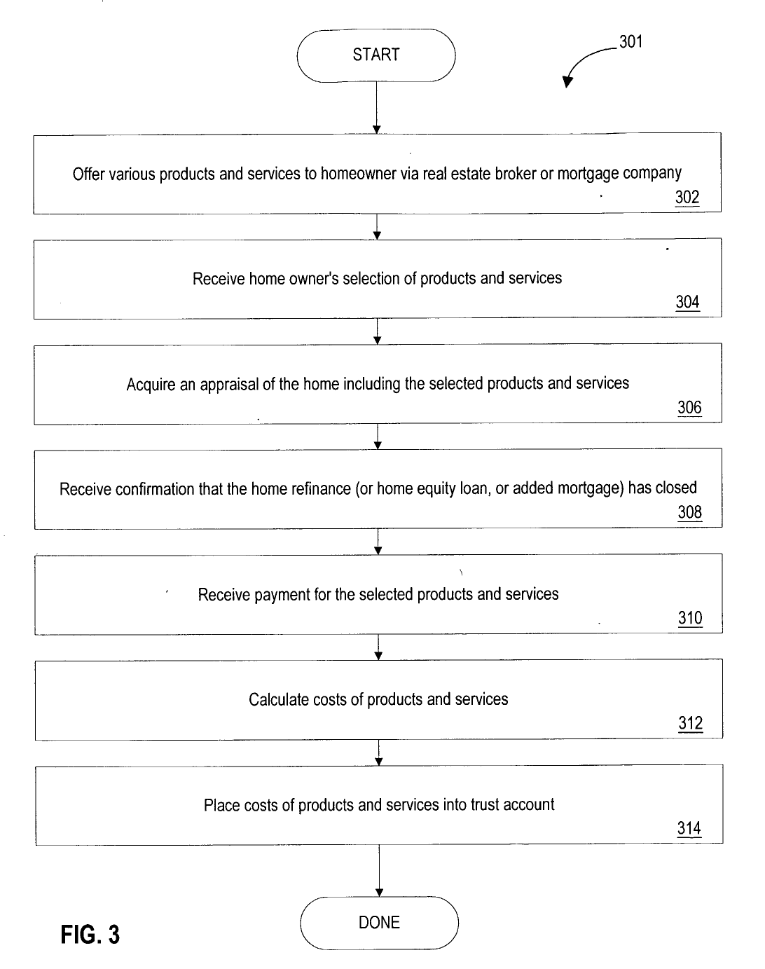

FIG. 3 is a flowchart of a method 301 for a bundling company 102 to provide products and services to homeowners 110 during a house refinance, home equity loan, or second mortgage (generically referred to as a “mortgage transaction”), in accordance with one embodiment of the present invention. The method 301 starts in step 302 where the bundling company 102 offers various products and services to a homeowner 110 via a real estate broker or mortgage broker 109. The method 301 then moves to step 304 where the bundling company 102 receives the homeowner's selection of products and services.

In step 306, the bundling company 102 acquires an appraisal of the home including the selected products and services. Next, in step 308, the bundling company 102 receives confirmation that the home refinance (or home equity loan, or added mortgage) has closed. In step 310, the bundling company 102 then receives payment for the selected products and services. Moving to step 312, the bundling company 102 calculates the costs of the products and services. From the received payment, the bundling company then places these costs for the products and services into a trust account on behalf of the homeowner 110 in step 314. The method is then done.

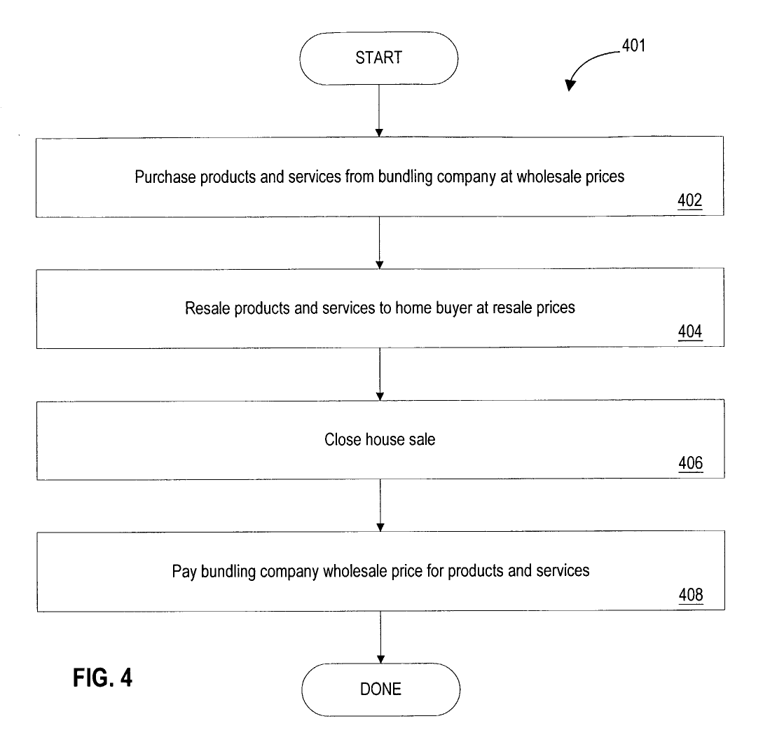

FIG. 4 is a flowchart of a method 401 for a builder or developer (each generically referred to as a client 111) to provide products and services to homebuyers 110 during a house sale, in accordance with one embodiment of the present invention. The method 401 starts in step 402 where the builder or developer purchases products and services from a bundling company 102 at wholesale prices. Moving to step 404, the builder or developer 404 resells the products and services to a homebuyer 110 at resale prices. Next, in step 406, the builder or developer closes the house with the homebuyer 110. The builder or developer then pays the bundling company the agreed upon wholesale prices of the products and services in step 408. The method is then done.

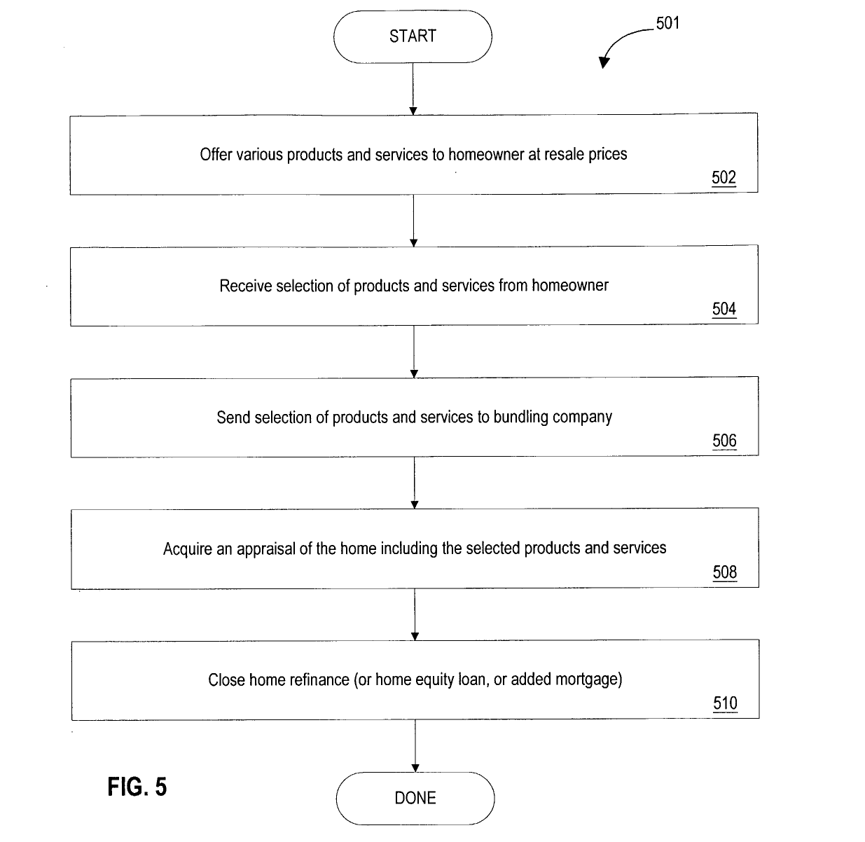

FIG. 5 is a flowchart of a method 501 for a real estate broker or mortgage company (each generically referred to as a client 111) to provide products and services to homeowners 110 during a house refinance, home equity loan, or second mortgage (each generically referred to as a “mortgage transaction”), in accordance with one embodiment of the present invention. The method 501 starts in step 502 where the broker offers various products and services to the homeowner 110 at resale prices. The method 501 then moves to step 504 where the broker receives selection of the products and services from the homeowner 110. Then, in step 506, the broker sends this selection of products and services to the bundling company 102. The broker, in step 508, acquires an appraisal of the home including the selected products and services. The broker then closes the home refinance (or home equity loan, or added mortgage) with the homeowner 110 in step 510. The method is then done.

System and Method Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, selling products and services to a client at wholesale prices, calculating a cost of selected products and services, integrating the cost of the selected products and services into a purchase price of the home, acquiring an appraisal that includes the price of the products and services, acquiring an approval of a mortgage for the purchase price of the home, allowing the mortgage to close, and placing orders directly via the computer to the products and services suppliers 104, according to processes of the present invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method for a bundling company to provide products and services to a homebuyer in a house sale, the method comprising:
selling products and services to a client at wholesale prices;
calculating a cost of selected products and services;
integrating the cost of the selected products and services into a purchase price of the home;
acquiring an appraisal of the home including the selected products and services;
acquiring an approval of a mortgage for the purchase price of the home; and
allowing the mortgage to close.

2. The method of claim 1, further comprising establishing the products and services as being real property.

3. The method of claim 2, wherein the products and services are telecom services including at least one of:
base telecom services;
video services;
long-distance telephone services;
internet services;
home security services; and
structured wiring.

4. The method of claim 2, wherein the products and services are utility services including at least one of:
energy;
water;
electricity;
gas;
waste disposal; and
recycling.

5. The method of claim 1, wherein the client is a land developer or a home builder.

6. The method of claim 1, wherein the step of receiving payment for the products and services includes receiving prepayment for a block of time for the homebuyer to use the products and services.

7. The method of claim 6, further comprising tying the block of time to real property where the products and services will be used.

8. The method of claim 1, further comprising:
receiving payment for the selected products and services; and
placing the cost of the selected products and services into a trust account.

9. The method of claim 8, further comprising:
receiving a single consolidated invoice from suppliers of the products and services;
withdrawing from the trust account the amount of the single consolidated invoice; and
paying the products and services suppliers.

10. The method of 8, further comprising scheduling funds placed in the trust account to be released to the homebuyer upon an inability of the bundling company to perform its duties to the homebuyer.

11. A method for a bundling company to provide products and services to a homeowner during a mortgage transaction, the method comprising:
offering various products and services to the homeowner via a client;
receiving the homeowner's selection of products and services;
acquiring an appraisal of the home including the selected products and services;
receiving confirmation that the mortgage transaction has closed;
receiving payment for the products and services;
calculating costs of the products and services; and
placing costs of products and services into a trust account on behalf of the homeowner.

12. The method of claim 11, wherein the mortgage transaction is at least one of a house refinance, a home equity loan, and a second mortgage.

13. A method for a client of a bundling company to provide products and services to a homebuyer during a house sale, the method comprising:
purchasing products and services from the bundling company at wholesale prices;
reselling the products and services to the homebuyer at resale prices;
closing the house sale; and
paying the bundling company the wholesale prices for the products and services.

14. The method of claim 13, wherein the client is at least one of a homebuilder and a land developer.

15. A method for a client of a bundling company to provide products and services to homeowners during a mortgage transaction, the method comprising:
offering various products and services to the homeowner at resale prices;
receiving a selection of products and services from the homeowner;
sending the selection of products and services to the bundling company;
acquiring an appraisal of the home including the selected products and services; and
closing the mortgage transaction.

16. The method of claim 15, wherein the client is at least one of a real estate broker and a mortgage company.

17. A bundling company configured to provide products and services to a homebuyer in a house sale, wherein the bundling company is set up to perform the steps of:
selling products and services to a client at wholesale prices;
calculating a cost of selected products and services;
integrating the cost of the selected products and services into a purchase price of the home;
acquiring an appraisal of the home including the selected products and services;
acquiring an approval of a mortgage for the purchase price of the home; and
allowing the mortgage to close.

18. The bundling company of claim 17, wherein the bundling company is a consumer advocate.

19. The bundling company of claim 17, wherein the bundling company is supplier agnostic.

20. A computer-readable medium carrying one or more sequences of one or more instructions for providing products and services to a homebuyer in a house sale, the one or more sequences of one or more instructions including instructions which, when executed by one or more processors, cause the one or more processors to perform steps of:
selling products and services to a client at wholesale prices;
calculating a cost of selected products and services;
integrating the cost of the selected products and services into a purchase price of the home;
acquiring an appraisal of the home including the selected products and services;
acquiring an approval of a mortgage for the purchase price of the home;
allowing the mortgage to close; and
ordering the products and services from suppliers of the products and services.
